(19) United States
(12) Patent Application Publication
(10) Pub. No.: US 2006/0077817 A1
(43) Pub. Date: Apr. 13, 2006

(54) Method and apparatus for reproducing data from recording medium using local storage

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/224,243

(22) Filed: Sep. 13, 2005

Related U.S. Application Data
(60) Provisional application No. 60/608,884, filed on Sep. 13, 2004.
(60) Provisional application No. 60/617,080, filed on Oct. 12, 2004.

(30) Foreign Application Priority Data
Nov. 24, 2004 (KR) 10-2004-0096846

(51) Int. Cl. G11B 19/02

(52) U.S. Cl. 369/47.1; 369/53.2; 369/59.1

(57) ABSTRACT

A method and apparatus for reproducing data from a recording medium using a local storage is disclosed. The method for reproducing data of a recording medium using a local storage includes (a) reading a binding unit associated with a specific recording medium from the local storage; (b) forming a virtual file structure using a binding operation for combining the binding unit with a file structure recorded in the recording medium; and (c) reproducing data contained in the recording medium and/or data contained in the local storage using the formed virtual file structure.

This application claims the benefit of the U.S. Provisional Application No. 60/608,884, filed on Sep. 13, 2004, in the name of inventors Kang Soo SEO, Jea Yong YOO, and Byung Jin KIM, entitled “METHOD OF USING LOCAL STORAGE IN BLU-RAY DISC”, and No. 60/617,080, filed on Oct. 12, 2004, in the name of inventors Kang Soo SEO, Jea Yong YOO, and Byung Jin KIM, entitled “PLAYBACK CONTROL OF THE BLU-RAY DISC IN CONNECTION WITH LOCAL STORAGE AND NETWORK (1)”, which are hereby incorporated by reference as if fully set forth herein.

This application claims the benefit of Korean Patent Application No. 10-2004-0096846, filed on Nov. 24, 2004, which is hereby incorporated by reference as if fully set forth herein.

### BACKGROUND OF THE INVENTION

1. Field of the Invention

The present invention relates to a method and apparatus for reproducing data from a recording medium, and more particularly to a method and apparatus for reproducing data from a recording medium using a local storage contained in an optical recording/reproducing device.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

In association with the above-mentioned situation, there has recently been developed an optical recording/reproducing device based on the BD international standard, but the BD international standard has not yet been completed, such that many limitations and obstacles to the development of the optical recording/reproducing device remain.

Particularly, the above-mentioned optical recording/reproducing device must consider not only a basic function for recording/reproducing data of the BD, but also an additional function for enabling the optical recording/reproducing device to interact with peripheral digital devices. In other words, the optical recording/reproducing device must receive an external input signal, must display the received signal, and must reproduce desired data using the external input signal and the BD.

However, a method for reproducing data from the recording medium to simultaneously reproduce the external input signal and data of the BD has not yet been established, such that many limitations and obstacles to the development of a BD-based optical recording/reproducing device remain.

### SUMMARY OF THE INVENTION

Accordingly, the present invention is directed to a method and apparatus for reproducing data from a recording medium using a local storage that substantially obviate one or more problems due to limitations and disadvantages of the related art.

An object of the present invention is to provide a method and apparatus for reproducing data suitable for a recording medium.

Another object of the present invention is to provide a method for forming a virtual file structure which includes a local storage capable of receiving/storing data from an external part, and simultaneously reproduces data stored in the local storage and data recorded in a recording medium.

A further object of the present invention is to provide a method and apparatus for reproducing both data recorded in a recording medium and data stored in a local storage using a virtual file structure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing data of a recording medium using a local storage includes the steps of (a) reading a binding unit associated with a specific recording medium from the local storage; (b) forming a virtual file structure using a binding operation for combining the binding unit with a file structure recorded in the recording medium; and (c) reproducing data contained in the recording medium and/or data contained in the local storage using the formed virtual file structure.

In another aspect of the present invention, a method for forming a virtual file structure includes the steps of (a) reading an original playlist file for reproducing original data recorded in a recording medium, and reading an additional playlist file associated with the original playlist file from a local storage; (b) combining the original playlist file with the additional playlist file, and forming a virtual playlist file for reproducing the original data recorded in the recording medium and/or the additional data recorded in the local storage; and (c) forming a virtual file structure which includes at least one virtual playlist file to reproduce the original data and/or the additional data.

In a further aspect of the present invention, an apparatus for reproducing data of a recording medium includes a pickup unit for reading original data from a recording medium; a local storage for storing additional data associated with the original data; and a controller for forming a virtual file system to reproduce the original data and/or the additional data, and forming a virtual file structure including the original data and associated additional data using the virtual file system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a method and apparatus for reproducing data from a recording medium according to the present invention;

FIG. 2 is a conceptual diagram illustrating a file structure recorded in an optical disc acting as a recording medium and a method for reproducing a specific title using the file structure;

FIG. 3 is a structural diagram illustrating a data record structure of an optical disc acting as a recording medium according to the present invention;

FIG. 4a is a block diagram illustrating an optical recording/reproducing device according to the present invention;

FIG. 4b is a block diagram illustrating an apparatus for reproducing data using a local storage from among overall components contained in the optical recording/reproducing device according to the present invention;

FIG. 5 is a conceptual diagram illustrating a method for forming a virtual package capable of reproducing data recorded in a recording medium and data recorded in a local storage according to the present invention;

FIG. 6a is a conceptual diagram illustrating a method for forming the virtual package using a virtual file system (VFS) on the basis of a file structure according to the present invention;

FIG. 6b exemplarily shows a variety of additional data types stored in a local storage according to the present invention;

FIGS. 7a-7b are conceptual diagrams illustrating a method for forming a virtual playlist (Virtual PlayList) contained in the virtual package in accordance with a first preferred embodiment of the present invention;

FIG. 8 is a conceptual diagram illustrating a method for forming a virtual playlist (Virtual PlayList) contained in the virtual package in accordance with a second preferred embodiment of the present invention;

FIG. 9 is a conceptual diagram illustrating a method for forming a virtual playlist (Virtual PlayList) contained in the virtual package in accordance with a third preferred embodiment of the present invention; and

FIG. 10 is a flow chart illustrating a method for reproducing data from a recording medium using a local storage according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium using a local storage will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all storage mediums, for example, an optical disc, and a magnetic tape, etc., according to various recording schemes. For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

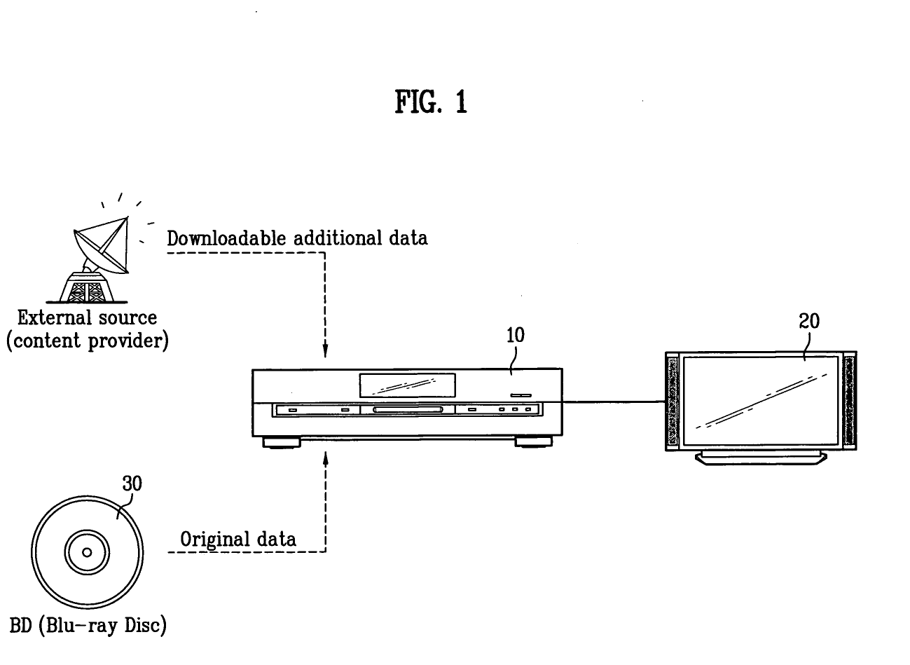

The term “local storage” is indicative of a storage unit contained in an optical recording/reproducing device 10 shown in FIG. 1. In more detail, the term “local storage” is indicative of a component capable of receiving necessary information or data from a user, and storing the received information or data. For example, a general local storage may be indicative of a Hard Disc Drive (HDD), but it should be noted that the term “local storage” of the present invention is not limited to the HDD, and is applicable to other examples as necessary.

Particularly, the term “local storage” is used as a storage unit for storing data associated with a recording medium such as a BD. The data associated with the recording medium is generally downloaded from an external device. In association with the above-mentioned description, it will be obvious to those skilled in the art that the local storage may directly read some permission data from the recording medium, and may generate system data (e.g., metadata) associated with record/reproduction operations of the recording medium, such that the system data may be stored in the local storage.

The term “binding unit” is indicative of a set of files stored in the local storage. Particularly, the binding unit is indicative of a specific unit associated with a specific recording medium. In this case, the specific unit is combined with or is added to a file contained in the recording medium, such that it can simultaneously reproduce data of the recording medium and data of the local storage.

The term “virtual file structure” is indicative of a virtual file for simultaneously reproducing data of the recording medium and/or data of the local storage. The virtual file structure is formed by a binding operation for virtually integrating the binding unit and a file structure of the recording medium. The virtual file structure is indicative of a virtual package, and the file structure of the recording medium may also be referred to as a disc package.

The term “binding information” determines files for forming the binding unit, and controls the execution of the binding operation. Preferably, the binding information may be formed of a single file for each recording medium. Generally, a file for forming the above-mentioned binding information is downloaded from an external device, and is then stored in the local storage.

For the convenience of description, data recorded in the recording medium is referred to as “original data”, data associated with the recording medium from among a plurality of data units stored in the local storage is referred to as “additional data”.

FIG. 1 is a conceptual diagram illustrating a method and apparatus for reproducing data according to the present invention. Unified usages of the optical recording/reproducing 10 and peripheral devices are shown in FIG. 1.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention uses a BD-player capable of reproducing data from the BD or a BD-recorder capable of recording data in the BD in consideration of correlation between the BD and peripheral devices for the convenience of description. It is well known in the art that the optical recording/reproduction device 10 is also applicable to a drive embedded in a specific device such as a computer.

The optical recording/reproducing device 10 records or reproduces data in/from the optical disc 30, receives an external input signal, performs a signal process on the received signal, and transmits the signal processed result to the external display 20, such that a user can view the signal processed result on the display 20. In this case, there is no limitation in a receivable external signal. For example, representative external input signals may be determined to be a DTV-associated signal and an Internet-associated signal, etc. Specifically, the Internet is indicative of a communication network to which a user easily gains access, such that the user can download specific Internet data using the optical recording/reproducing device 10, and can use the downloaded data. In association with the above-mentioned description, an enterprise for providing content data used as an external source is generally referred to as a content provider (CP).

When original data is recorded in the optical disc 30 seated in the optical recording/reproducing device 10, and additional data associated with the original data is present in other storage locations (e.g., Internet), the present invention aims to reproduce the original data and the additional data at the same time.

For example, it is assumed that multiplexed AV (Audio/Video) streams are recorded as the original data recorded in the optical disc, and additional data for use in the Internet is an audio stream different from an audio stream (e.g., Korean) of the original data. In this case, some users may download a specific audio stream (e.g., English) acting as additional data from the Internet, may desire to reproduce the downloaded audio stream along with the AV stream acting as original data, or may desire to reproduce only the additional data. In order to satisfy the above-mentioned desires of the users, correlation between the original data and the additional data must be established, and there is needed a systemized method for managing/reproducing the above-mentioned data according to a user request. The present invention provides a method for implementing the above-mentioned systemized method.

For the convenience of description, although a signal recorded in the disc is called the original data, and other signals existing outside of the disc are called the additional data, it should be noted that the original data and the additional data are not limited to specific data.

Generally, additional data may be indicative of audio data, presentation graphic (PG) data, interactive graphic data, or text subtitles, etc., but the additional data may also be indicative of a multiplexed AV stream including the above-mentioned data and video data. In other words, data associated with the original data simultaneously existing outside of the optical disc may act as additional data.

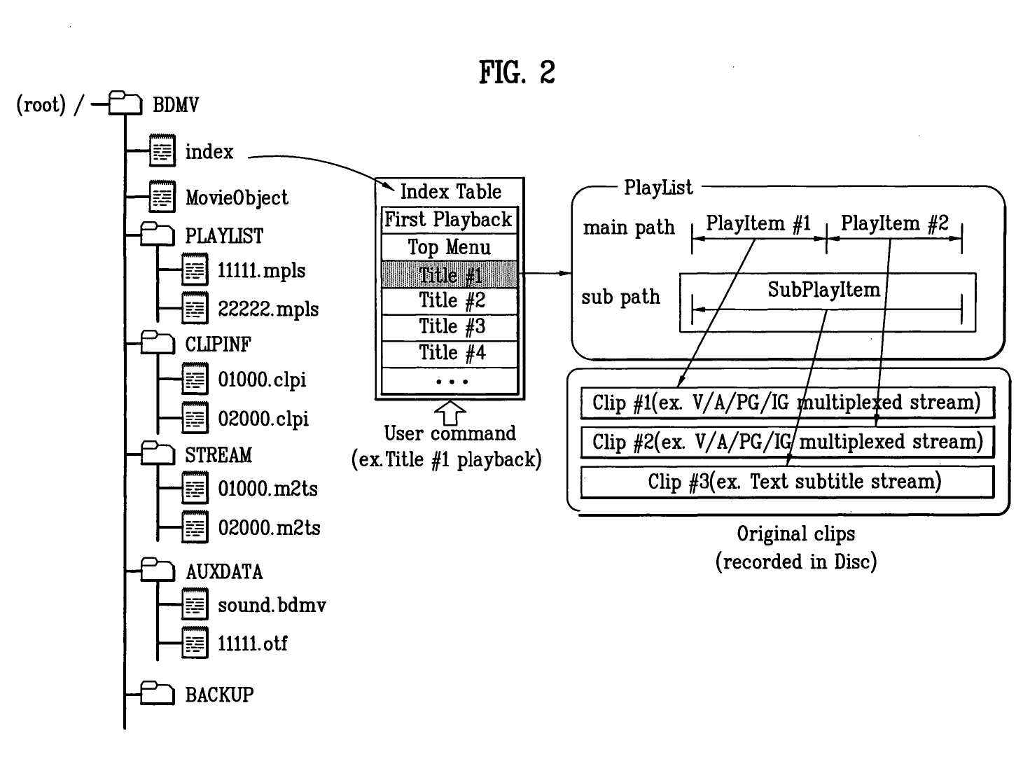

In order to satisfy the above-mentioned user requests, a predetermined file structure must be established between the original data and the additional data. Accordingly, a file structure and data record structure for use in the BD will hereinafter be described with reference to FIGS. 2□3.

FIG. 2 is a conceptual diagram illustrating a file structure for reproducing/managing the original data recorded in an optical disc, and a method for reproducing a specific title according to the file structure. It should be noted that the file structure can also be referred to as a disc package as necessary, as previously stated above.

An example of the above-mentioned file structure is shown in FIG. 2. The file structure according to the present invention includes one or more BD directories (BDMV) under a single root directory. The BD directory (BDMV) includes not only an index file “index” acting as a general file (i.e., an upper file) capable of guaranteeing user interactivity, but also the above-mentioned object. The file structure includes a variety of directories for storing information of actual data recorded in a disc and other information associated with a method for reproducing the data, for example, a playlist directory (PLAYLIST), a clip information directory (CLIPINF), a stream directory (STREAM), an auxiliary directory (AUXDATA), and a backup directory (BACKUP). The above-mentioned directories and a variety of files included in the directory will hereinafter be described.

The AUXDATA directory includes an additional data file for reproducing data of the disc. For example, the AUXDATA directory includes a “Sound.bdmv” file for providing a user with sound data when an interactive graphic function is executed, and an “11111.otf” file for providing the user with font information when data of the disc is reproduced.

The stream directory (STREAM) includes a plurality of AV stream files recorded in a disc according to a specific format. Generally, individual streams are recorded using an MPEG-2 based transport packet, and the stream directory (STREAM) uses extension names of stream files (01000.m2ts and 02000.m2ts) as a specific extension name “*.m2ts”. Particularly, if video/audio/graphic information from among the above-mentioned streams is multiplexed, the multiplexed information is called an AV stream, and a single title is composed of at least one AV stream file.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) record attribute information and timing information of the stream files (*.m2ts) therein. The clip-info files (*.clpi) connected to the stream files (*.m2ts) on a one-to-one basis are generically named a “Clip”. In other words, this means that a single clip is indicative of data composed of a stream file (*.m2ts) and a clip-info file (*.clpi). A clip recorded in the disc is referred to as an original clip. A clip, which is downloaded and stored in a local storage, is referred to as an additional clip.

The playlist directory (PLAYLIST) includes a plurality of playlist files (*.mpls). Each playlist file (*.mpls) includes one or more playitems (PlayItem) and one or more sub-playitems (SubPlayItem). Each playitem (PlayItem) and each sub-playitem (SubPlayItem) are adapted to designate a playing interval during which a specific clip is reproduced. The playitem (PlayItem) and the sub-playitem (SubPlayItem) include information associated with a specific clip to be reproduced, i.e., information associated with a reproduction start time (IN-Time) and other information associated with a reproduction termination time (OUT-Time) of the specific clip.

In association with the above-mentioned description, a process for reproducing data using at least one playitem (PlayItem) in the playlist file is referred to as a main path, and a process for reproducing data using individual sub-play items (SubPlayItem) is referred to as a sub-path. The playlist file must contain a single main path. The playlist file may contain at least one sub-path according to the presence or absence of the sub-playitem (SubPlayItem) as necessary.

In conclusion, the playlist file acts as a basic reproduction/management file unit contained in overall reproduction/management file structures for reproducing a desired clip by combination of one or more playitems (PlayItem).

The backup directory (BACKUP) stores a plurality of duplicate files, i.e., a duplicate file (also called “copied files”) of the index file “index” storing information associated with disc reproduction, a duplicate file of the object file “MovieObject”, duplicate files of all playlist files (*.mpls) contained in the playlist directory (PLAYLIST), and duplicate files of all clip-info files (*.clpi) contained in the clip-info directory (CLIPINF). If the above-mentioned files (“index”, “MovieObject”, “*.mpls”, and “*.clpi”) are damaged, a disc reproduction process is also fatally damaged, such that the backup directory (BACKUP) is designed to pre-store duplicate files of the above-mentioned files as backup files.

In association with the above-mentioned description, a method for reproducing a specific title using the above-mentioned disc file structure is shown in FIG. 2.

If a user enters a title reproduction command in association with a title used as an index file (also called “index table”), reproduction of the title begins. A detailed description thereof will hereinafter be described.

The index file (index.bdmv) includes first playback information “First Playback” indicative of information associated with a first reproduction image when data of a corresponding disc is loaded, top menu information “Top_Menu” for providing a menu image, and at least one title information “Title #1 □Title #n”.

If the disc 30 is loaded in the optical recording/reproducing device 10, title menu information associated with the index table is provided to the user via the display 20. If the user selects a specific title or a specific menu contained in a menu image, data reproduction begins according to a scenario pre-defined by a disc manufacturer. In other words, if the user enters a command for reproducing a specific title (e.g., title #1), a specific playlist file is executed according to a command contained in the object file (MovieObject) of the reproduction/management file structure. Thereafter, one or more clips (e.g., Clip #1 □ Clip #3) constructing the title #1 are reproduced by a specific playitem and/or sub-playitem contained in the playlist file.

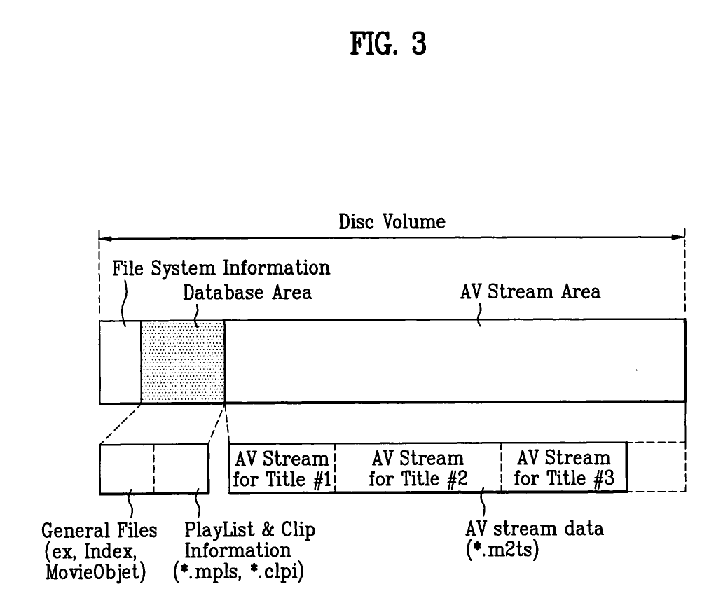

FIG. 3 is a structural diagram illustrating a data record structure recorded in a recording medium according to the present invention. In more detail, FIG. 3 shows a disc record format of information associated with the file structure. As shown in FIG. 3, from the viewpoint of an inner area of the disc, the above-mentioned disc structure sequentially includes a file system information area serving as system information for managing overall files, a database area for recording a playlist file and a clip-info file to reproduce a recorded AV stream (*.m2ts), and an AV stream area for recording a plurality of streams composed of audio data, video data, and graphic data, etc. Particularly, it should be noted that data recorded in the AV stream area may be determined to be original data as previously stated above.

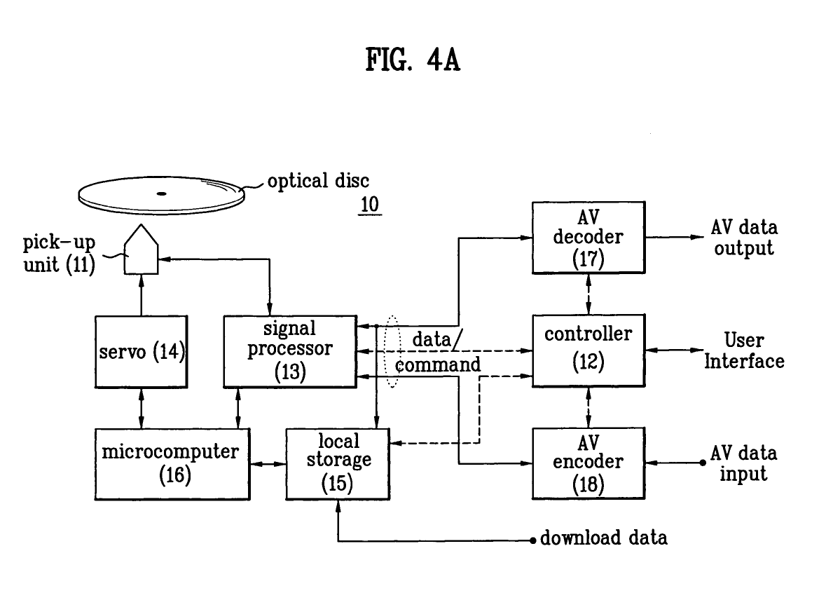

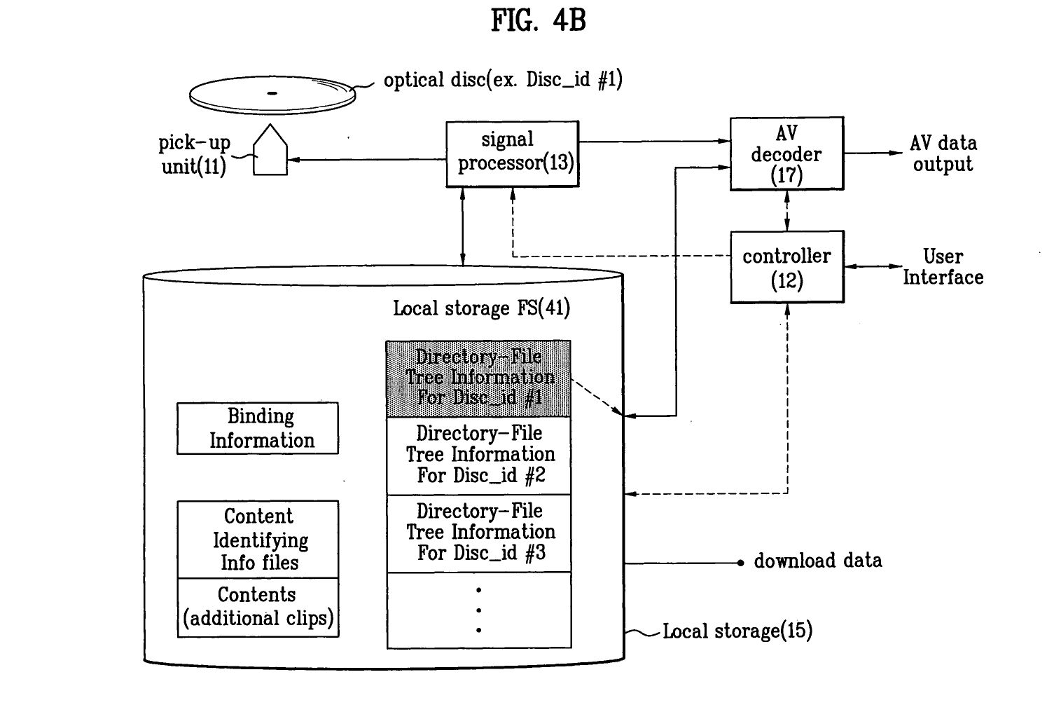

FIG. 4a is a block diagram illustrating the optical recording/reproducing device 10 according to the present invention.

Referring to FIG. 4a, the optical recording/reproducing device 10 includes a pickup unit 11, a servo unit 14, a signal processor 13, and a microprocessor 16. The pickup unit 11 reproduces original data recorded in the optical disc and management information including reproduction/management file information. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the restored or modulated result. The microprocessor 16 controls mutual operations of the above-mentioned components.

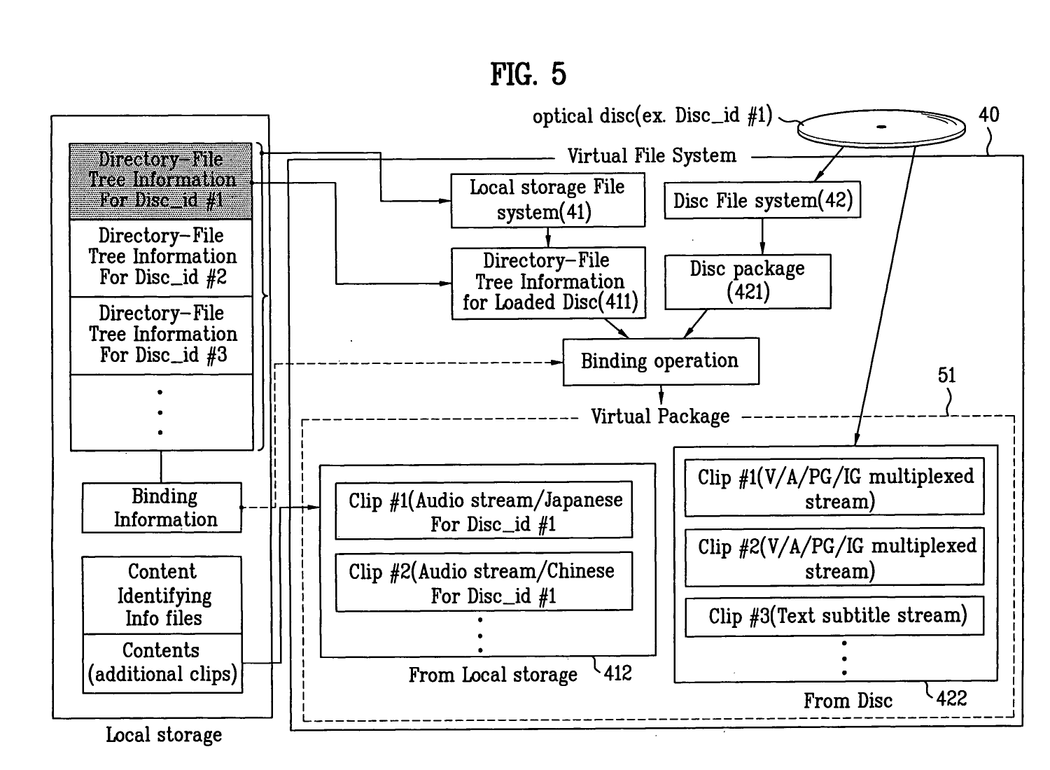

A controller 12 downloads additional data existing, outside of the optical disc upon receiving a command from a user, stores the downloaded additional data in the local storage 15, and configures a virtual file system (VFS) to reproduce the original data recorded in the optical disc and the additional data stored in the local storage. The controller 12 forms a virtual package including the original data and associated additional data using the VFS, and reproduces the original data and/or the additional data using the formed virtual package upon receiving a request from a user. In association with the above-mentioned description, a detailed description of the VFS and the virtual package will hereinafter be described with reference to drawings from FIG. 5.

A decoder 17 finally decodes output data (i.e., original data and/or additional data) upon receiving a control signal from the controller 12, and provides the user with the decoded result.

An encoder 18 converts an input signal into a specific format signal (e.g., an MPEG2 transport stream) upon receiving a control signal from the controller 12, and transmits the converted result to the signal processor 13.

The new virtual package may be stored in the local storage 15 such that it can be re-used in future. Also, the new virtual package may be temporarily stored in an additional dynamic memory, and may then be used.

FIG. 4b is a block diagram illustrating an apparatus for reproducing data of an optical disc using a local storage from among overall components contained in the optical recording/reproducing device 10 according to the present invention.

Information stored in the local storage 15 will hereinafter be described. The local storage 15 according to the present invention stores file information (Directory-File Tree Information for Disc_id #n) including directories and files for every individual disc identification (ID) information, and a plurality of additional clips downloaded from an external part. The local storage 15 may further store binding information for a binding operation associated with a disc package, and a plurality of files (Content Identifying Info files) for explaining content data stored in the local storage 15.

Specifically, the local storage 15 may include a plurality of file information units (Directory-File Tree Information for Disc_id #n) to cope with different discs. Therefore, the local storage 15 additionally requires a file system for managing the above-mentioned file information units. Specifically, the file system is also referred to as a local storage file system 41, and the local storage file system 41 is indicative of a system for managing all files stored in the local storage 15.

Therefore, if an optical disc of a specific disc ID (Disc_id) is loaded in the optical recording/reproducing device 10, the controller 12 contained in the optical recording/reproducing device 10 recognizes ID information of the disc using the pickup unit 11 and the signal processor 13, reads file information equal to the loaded disc ID information from among all file information units stored in the local storage 15, forms a virtual package by binding (or combining) the read information and the disc package, and reproduces both the original data of the disc and the additional data of the local storage using the formed virtual package.

A preferred embodiment for generating the virtual package according to the present invention will hereinafter be described.

FIG. 5 is a conceptual diagram illustrating a method for forming the above-mentioned virtual package according to the present invention.

If a specific disc is loaded in the optical recording/reproducing device 10 on the condition that the information and contents shown in FIG. 4b are stored in the local storage 15, the optical recording/reproducing device 10 reads the file system information 41 contained in the local storage 15, and at the same time reads disc file system information 42 including the file structure recorded in the disc, resulting in the creation of the VFS. In more detail, the virtual file system (VFS) is indicative of a file system virtually formed to manage both the file system contained in the local storage 15 and the other file system of the loaded disc.

The optical recording/reproducing device forms a new virtual package to simultaneously reproduce original data recorded in the disc and additional data recorded in the local storage using the above-mentioned virtual file system (VFS). For this purpose, the optical recording/reproducing device 10 reads file information (Directory-File Tree Information for Disc_id #n) associated with the disc (e.g., Disc_id #1) from the file system, and performs a binding operation for combining the read file information with a disc package of the loaded disc (Disc_id #1) or adding the read file information to the disc package.

The virtual package formed by the above-mentioned binding operation is indicative of a file structure for reproducing/managing an original clip 422 and an additional clip 412. The original clip 422 is composed of original data recorded in the disc. The additional clip 412 is composed of additional data recorded in the local storage.

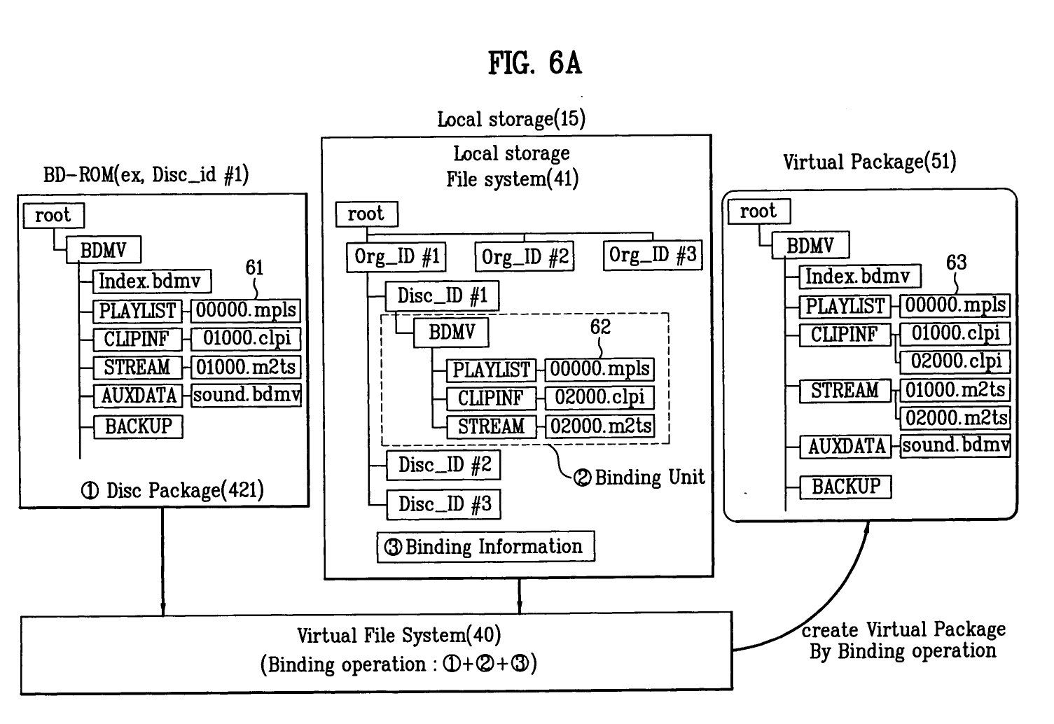

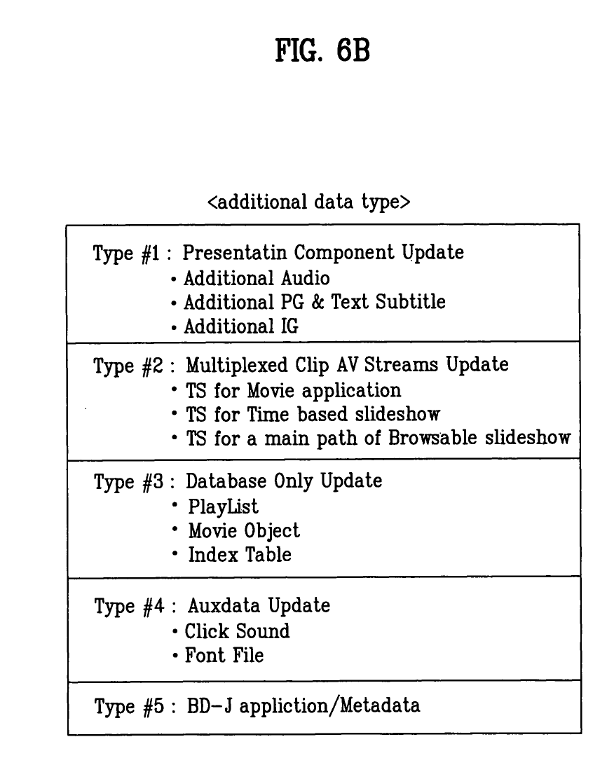

FIG. 6a is a conceptual diagram illustrating a method for forming the virtual package using a virtual file system (VFS) on the basis of a file structure according to the present invention.

Referring to FIG. 6a, a specific disc package (e.g., the structure of FIG. 2) is recorded in the loaded disc. A local storage file system 41 is contained in the local storage. The local storage file system 41 includes a binding unit and binding information, which are combined with the loaded disc (e.g., Disc_id #1).

In association with the above-mentioned description, the binding unit is similar to the disc package. Specifically, the binding unit may include a playlist file having the same name as that of a specific playlist file contained in the disc, such that it can be combined with the specific playlist file. However, it should be noted that the binding unit cannot be operated as a reproduction/management file by itself, differently from the disc package. If it is assumed that the binding unit is designed to perform data reproduction by itself, this data reproduction is similar to data reproduction of the local storage, such that the above-mentioned operations of the binding unit are contrary to the purpose of the present invention for simultaneously reproducing both original data recorded in the disc and additional data recorded in the local storage.

The binding information includes a variety of information units associated with the binding unit, for example, file types of the binding unit, update times of the binding unit, and a binding method, etc.

Therefore, the virtual file system (VFS) performs a binding operation for combining the binding unit with the disc package of the loaded disc using the above-mentioned binding information, such that it forms a new virtual package.

For example, if the binding unit associated with the loaded disc (e.g., Disc_id #1) includes a first playlist file (00000.mpls), a clip (i.e., clip-info file “02000.clpi”) managed by the first playlist file (00000.mpls), and a stream file (02000.m2ts), the first playlist file (00000.mpls) contained in the binding unit is combined with a second playlist file (00000.mpls) contained in the disc package, resulting in the creation of a virtual package including a new playlist file (00000.mpls). In this case, the second playlist file (00000.mpls) has the same file name as that of the first playlist file (00000.mpls)).

For the convenience of description, it should be noted that the playlist file 61 contained in the disc package is referred to as an original playlist file 62 (Original PLayList), the playlist file 62 contained in the binding unit is referred to as an additional playlist file (additional PlayList), and the playlist file 63 formed by combining the original playlist file 61 with the additional playlist file 62 is referred to as a virtual playlist file 63 (virtual PlayList).

The clip-info files (*.clpi) and the stream files (*.m2ts) other than the virtual playlist file 63 in the virtual package are contained in the virtual package so as to achieve their unified management only. Individual contents of the clip-info files (*.clpi) and the stream files (*.m2ts) are not changed by the binding operation. In more detail, the clip-info file (01000.clpi) and the stream file (01000.m2ts) in the disc package are simply combined with the clip-info file (02000.clpi) and the stream file (02000.m2ts) in the binding unit without any change, such that the combined results are contained in the virtual package.

In association with the above-mentioned description, the index file (index) and the object file (MovieObject) (not shown) act as upper files, and may be updated from a conventional index file (index) and a conventional object file (MovieObject) on the basis of the virtual playlist file 63. The above-mentioned update operation occurs when the title is changed to another by the virtual playlist file 63. For example, if the addition of a new title, the deletion of a conventional title, or the change of a title reproduction scenario occurs, the above-mentioned update operation of the index and object files (index, MovieObject).

In association with the above-mentioned description, the file system structure 41 contained in the local storage includes a file structure for managing downloaded additional data. For example, the file structure includes “Org_id” directories for every content provider (CP) for providing additional data, and “Disc_id” directories for every specific disc in each of the Org_id” directories. The “Disc_id” directories are configured in the form of a hierarchial structure. Provided that the “Org_id #1” directory is determined to be a directory of a specific company “A” providing contents, the directories “Disc_id #1”□“Disc_id #3” are configured according to disc types provided from the “A” company, and the user downloads additional data associated with the “Disc_id #1” directory, the downloaded additional data is contained in the binding unit contained in the above-mentioned “Disc_id #1” directory. It will be obvious to those skilled in the art that the binding unit can also be composed of only the “Disc_id” directories other than the “Org_id” directories.

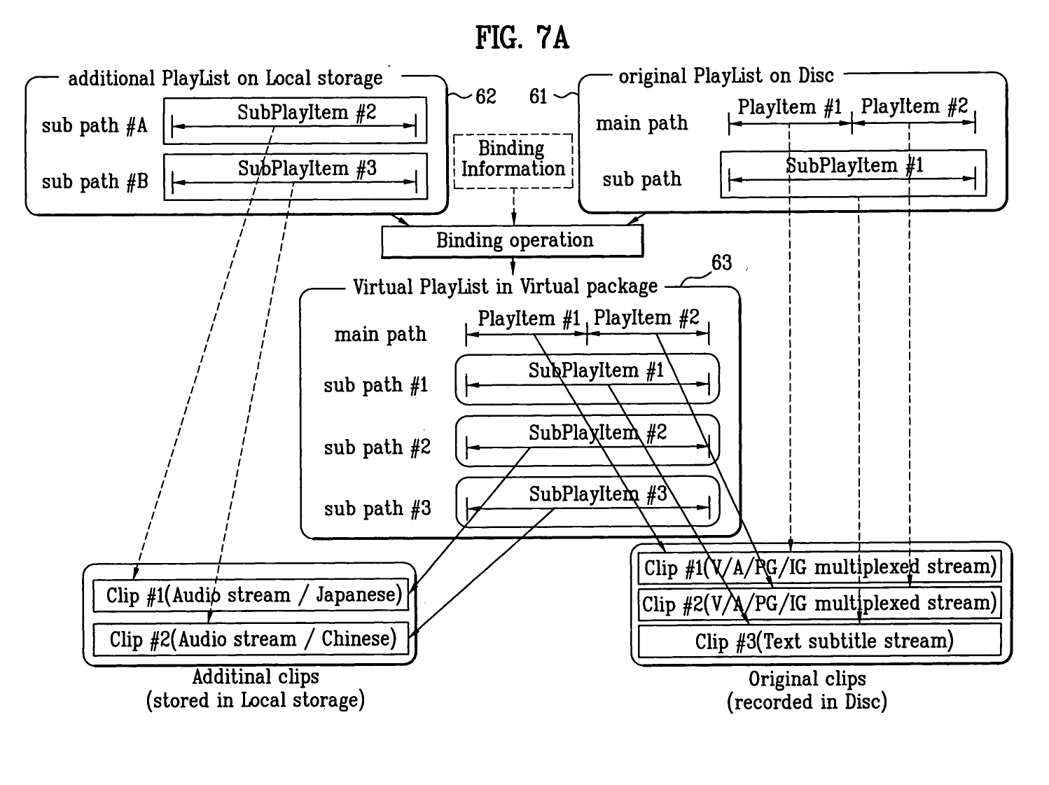

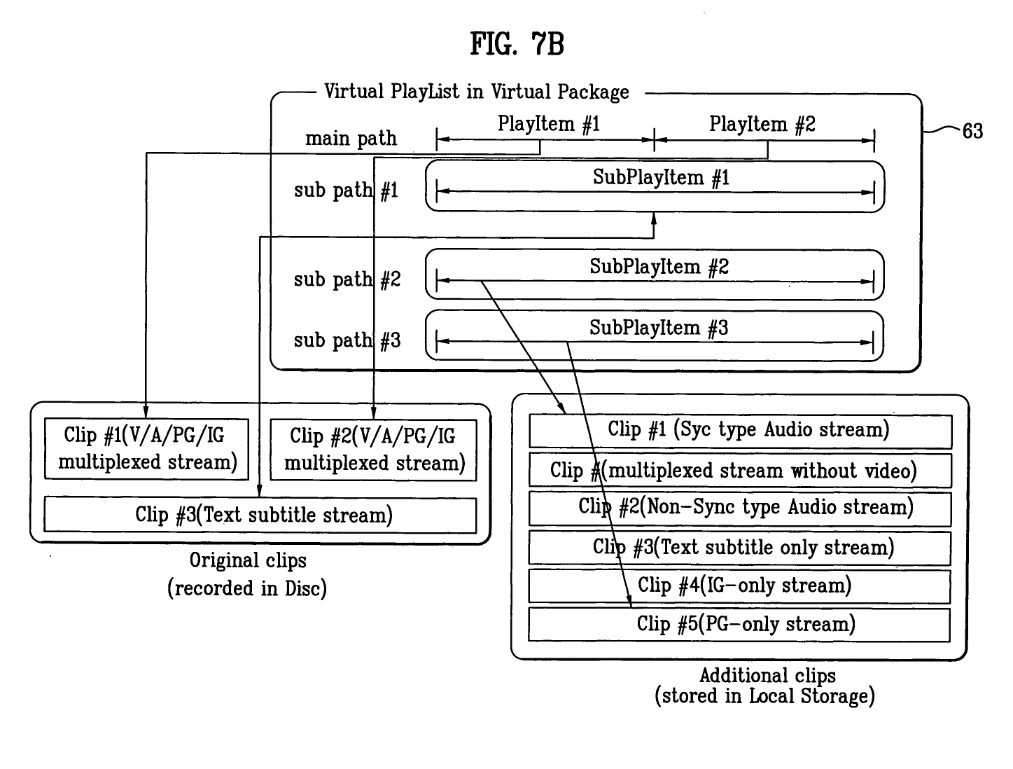

A method for forming the virtual playlist file 63 contained in a virtual package using the above-mentioned binding operation will hereinafter be described with reference to FIGS. 7a□9.

As stated above, the virtual package has the same structure as the disc package. Specifically, the virtual package includes a virtual playlist file 63 newly formed by the binding operation. By a reproduction/management method of the newly-formed virtual playlist file 63, an original clip (e.g., a clip-info file (01000.clpi)) and a stream file (01000.m2ts) in the virtual package are selectively reproduced, and/or an additional clip (e.g., a clip-info file (02000.clpi)) and a stream file (02000.m2ts) in the local storage are selectively reproduced.

Therefore, the virtual playlist file 63 contained in the virtual package serves as a basic reproduction/management file for simultaneously reproducing both original data recorded in the disc and additional data recorded in the local storage.

FIG. 6b exemplarily shows a variety of additional data types stored in the local storage according to the present invention. Specifically, FIG. 6b shows five additional data types according to additional data attributes.

Firstly, the additional data type #1 includes a plurality of data units for assisting the original data, for example, audio data, presentation graphic (PG) data, interactive graphic (IG) data, and text subtitle data (Text Subtitle), etc. The additional data type #1 is combined with the original playlist file 61 via a sub-path contained in the additional playlist file 62, and a detailed description thereof will hereinafter be described with reference to FIGS. 7a□7b.

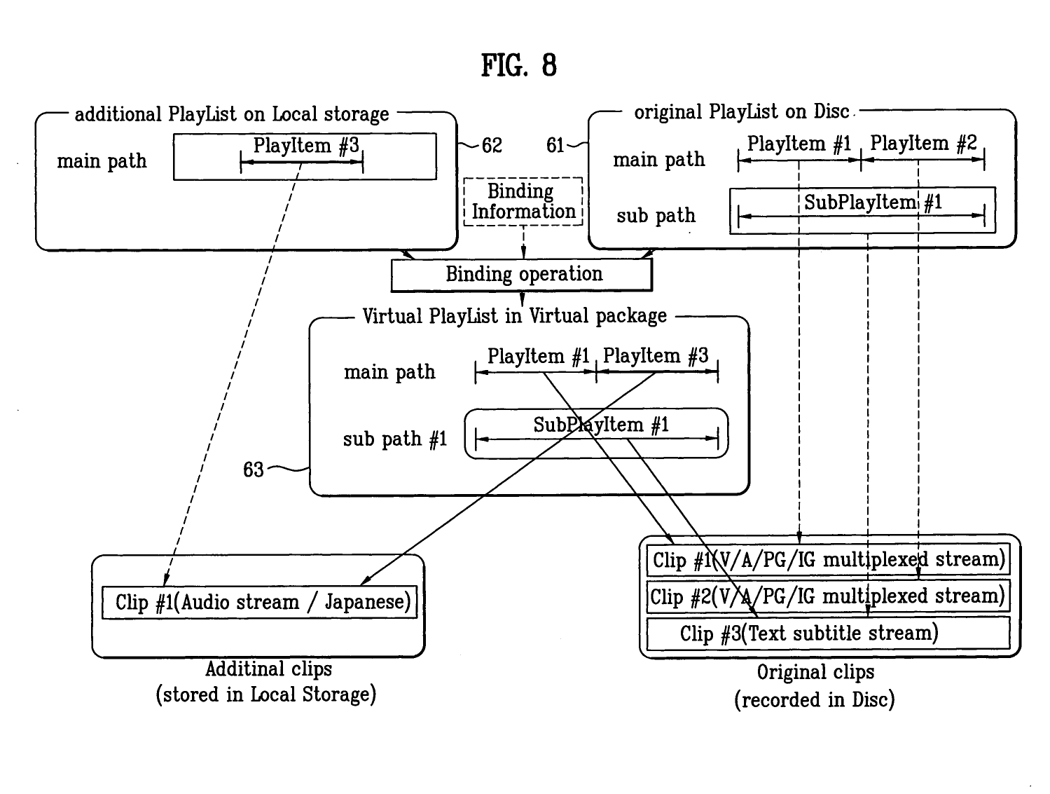

Secondly, the additional data type #2 includes a plurality of multiplexed-clip AV streams which are replaced with original data or are appended to the original data. The additional data type #2 is mainly combined with the original playlist 61 via a main path contained in the additional playlist 62, and a detailed description thereof will hereinafter be given with reference to FIG. 8.

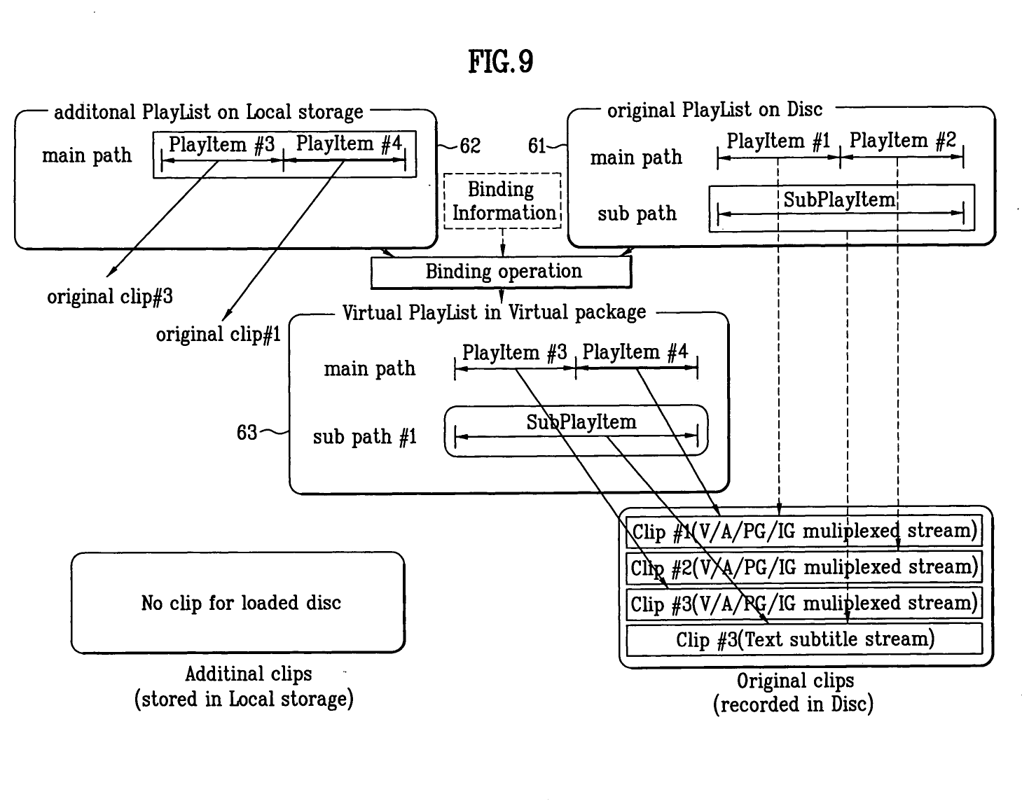

Thirdly, the additional data type #3 includes a plurality of data units (denoted by “Database only”) associated with conversion of a reproduction scenario for reproducing original data. For example, in the case where the order of the playitems contained in the playlist is changed, or the index file (index) or the object file (MovieObject) is changed, this means that only a reproduction/management file is changed/added with the absence of an actual additional clip. The above-mentioned additional data type #3 is associated with the above-mentioned case. The additional data type #3 is combined with the original playlist 61 using a main path contained in the additional playlist 62 according to a changed scenario, or is combined with the original index file (index) or the original object file (MovieObject) in the disc file structure using the additional index file (index) and/or the additional object file (MovieObject). A detailed description thereof will hereinafter be given with reference to FIG. 9.

Fourthly, the additional data type #4 includes a plurality of data units (Auxdata) associated with the auxiliary directory (AUXDATA) contained in the file structure. For example, the additional data type #4 is associated with the addition of click sound information or the addition of a font file for a text subtitle. The additional data type #4 is combined with the original sound file (sound.bdmv) or the original font file (*.otf) in the disc file structure using the additional sound file (sound.bdmv) and/or the additional font file (*.otf).

Fifthly, the additional data type #5 includes a plurality of data units used as system reproduction information. For example, the additional data type #5 is associated with Java application data (indicative of a BD reproduction mode) and/or system information used as system information. The additional data type #5 is combined with associated data contained in a system.

FIGS. 7a□7b are conceptual diagrams illustrating a method for forming the virtual playlist 63 in accordance with a first preferred embodiment of the present invention. Particularly, a method for employing a sub-path and a binding operation of the above-mentioned additional data type #1 are shown in FIGS. 7a□7b.

Referring to FIG. 7a, the original playlist 61 in the disc includes two playitems (PlayItems #1 and #2) contained in a main path and a single sub-playitem (SubPlayItem #1) contained in a sub-path. The original clip #1 indicative of a multiplexed AV stream is reproduced/managed by the playitem #1 contained in the main path. The original clip #2 indicative of a multiplexed AV stream is reproduced/managed by the playitem #2 contained in the main path. In this case, each multiplexed AV stream includes video data, audio data, and graphic data. Also, the original clip #3 constructing the text subtitle stream is reproduced/managed by the sub-playitem #1 (SubPlayItem #1) contained in the sub-path.

For example, the additional playlist 62 contained in the local storage does not include a main path, and includes a sub-playitem #2 (SubPlayItem #2) contained in a first sub-path #A and a sub-playitem #3 (SubPlayItem #3) contained in a second sub-path #B. The additional clip #1 constructing a Japanese audio stream is reproduced/managed by the sub-playitem #2 (SubPlayItem #2) contained in the sub-path #A. The additional clip #2 constructing a Chinese audio stream is reproduced/managed by the sub-playitem #3 (SubPlayItem #2) contained in the sub-path #B.

Therefore, the virtual playlist 63 is formed by combining the original playlist 61 with the additional playlist 62. In this case, the virtual playlist 62 is formed using the binding information.

In other words, a binding method can be determined by the above-mentioned binding information. For example, a binding method for adding two sub-paths #A and #b contained in the additional playlist 62 to the original playlist 61 can also be determined by the binding information.

Therefore, when the virtual file system (VFS) performs the binding operation, it forms a new virtual playlist 63 by referring to the original and additional playlists 61 and 62 and/or the binding information, such that the virtual package including at least one newly-formed virtual playlist 63 is formed. For another example, the binding operation can also be performed by a predetermined binding method without using the binding information.

In the above-mentioned case, the main path contained in the newly-formed virtual playlist 63 has the same structure as that of the original playlist 61. The sub-path #1 has the same structure as that of the sub-path contained in the original playlist 61. The sub-path #2 and the sub-path #3 have the same structures as those of the sub-paths #A and #B contained in the additional playlist 62.

In association with the above-mentioned description, the newly-formed virtual playlist 63 requires specific information for managing streams contained in the single main path and streams contained in three sub-paths. The specific information is referred to as “STN_Table” or “PID_table” information. Type and attribute information of streams selectable by a user are contained in the “STN_Table” or “PID_table” information. The system provides the user with information for allowing a specific sub-path to be selectively reproduced by the user with reference to the above-mentioned type and attribute information of the user-selected streams.

FIG. 7b is a structural diagram illustrating an additional data type #1 capable of being added as a sub-path according to the first preferred embodiment of the present invention.

Referring to FIG. 7b, the additional data type #1 capable of being added as the sub-path is classified into 6 data types, for example, a first additional clip #1 (denoted by “Sync type Audio stream”), a second additional clip #2 (denoted by “Non-Sync type audio stream”), a third additional clip #3 (denoted by “Text subtitle only stream”), a fourth additional clip #4 (denoted by “PG-only stream”), a fifth additional clip #5 (denoted by “IG-only stream), and an a sixth additional clip #6 (denoted by “multiplexed stream without video”). The first additional clip #1 synchronizes an additional audio stream with original data. The second additional clip #2 does not synchronize the additional audio stream with the original data. The additional clip #3 includes only a text subtitle. The additional clip #4 includes only a presentation graphic (PG) stream. The additional clip #5 includes only an interactive graphic (IG) stream. The additional clip #6 is formed by multiplexing at least two streams from among the additional clips #1□#5.

In association with the above-mentioned description, although the number of sub-paths contained in the virtual playlist 63 can be determined to be a plural number, there is a limitation in the number of sub-paths capable of being simultaneously processed when the reproduction operation is performed via sub-paths. Generally, the number of sub-paths is pre-defined in system specifications. For example, the number of sub-paths may be set to a predetermined number of 2, such that only two sub-paths can be simultaneously processed.

FIG. 8 is a conceptual diagram illustrating a method for employing a main path according to the second preferred embodiment for forming the virtual playlist 63. Specifically, the binding operation of the above-mentioned additional data type #2 is shown in FIG. 8.

In association with the above-mentioned, the additional data type #2 adds the additional clip composed of a multiplexed AV stream to the disc, or is used as data for substituting for a specific original clip.

Referring to FIG. 8, the original playlist 61 in the disc includes two playitems (PlayItems #1 and #2) contained in a main path and a single sub-playitem (SubPlayItem #1) contained in a sub-path. The original clip #1 indicative of a multiplexed AV stream is reproduced/managed by the playitem #1 contained in the main path. The original clip #2 indicative of a multiplexed AV stream is reproduced/managed by the playitem #2 contained in the main path. In this case, each multiplexed AV stream includes video data, audio data, and graphic data. Also, the original clip #3 constructing the text subtitle stream is reproduced/managed by the sub-playitem #1 (SubPlayItem #1) contained in the sub-path.

For example, the additional playlist 62 in the local storage includes a single playitem #3 (PlayItem #3) in a main path, and manages an additional clip #1 indicative of a multiplexed AV stream by a playitem (PlayItem #3) contained in the main path. In this case, each multiplexed AV stream includes video data, audio data, and graphic data.

In other words, a binding method can be determined by the above-mentioned binding information. For example, a binding method for replacing the playitem #2 contained in the original playlist 61 with the playitem #3 contained in the additional playlist 62 can be determined by the binding information.

Therefore, the finally-formed virtual playlist 63 includes the playitem #1 for reproducing/managing the original clip #1 and the playitem #3 for reproducing/managing the additional clip #1 in the main path. Also, the finally-formed virtual playlist 63 includes a sub-playitem #1 for reproducing/managing the original clip #3 in the sub-path.

FIG. 9 is a conceptual diagram illustrating a method for employing a main path according to the third preferred embodiment for forming the virtual playlist 63. Specifically, the binding operation of the above-mentioned additional data type #3 is shown in FIG. 9.

In association with the above-mentioned description, the additional data type #3 is associated with a specific case in which a reproduction scenario of the original data is changed without addition of an additional clip. Specifically, the additional data type #3 is associated with a method for changing a reproduction scenario using playlists.

Referring to FIG. 9, the original playlist 61 in the disc includes two playitems (PlayItems #1 and #2) contained in a main path and a single sub-playitem (SubPlayItem #1) contained in a sub-path. The original clip #1 indicative of a multiplexed AV stream is reproduced/managed by the playitem #1 contained in the main path. The original clip #2 indicative of a multiplexed AV stream is reproduced/managed by the playitem #2 contained in the main path. In this case, each multiplexed AV stream includes video data, audio data, and graphic data. Also, the original clip #3 constructing the text subtitle stream is reproduced/managed by the sub-playitem #1 (SubPlayItem #1) contained in the sub-path. Particularly, a first reproduction scenario for performing data reproduction in the order of the original clip #1→the original clip #2 via the main path is associated with the third preferred embodiment.

For example, the additional playlist 62 in the local storage includes two playitems #3 and #4 (PlayItem #3 and PlayItem #4) in a main path. The original clip #3 is reproduced/managed by the playitem #3 (PlayItem #3) of the main path. The original clip #1 is reproduced/managed by the playitem #4 (PlayItem #4) of the main path.

A binding method can be determined by the above-mentioned binding information. For example, a binding method for replacing the playitem #1 contained in the original playlist 61 with the playitem #3 contained in the additional playlist 62, or a binding method for replacing the playitem #2 contained in the original playlist 61 with the playitem #4 contained in the additional playlist 62 can be determined by the binding information.

Therefore, the finally-formed virtual playlist 63 includes the playitem #3 for reproducing/managing the original clip #3 and the playitem #4 for reproducing/managing the additional clip #1 in the main path. Also, the finally-formed virtual playlist 63 includes a sub-playitem #1 for reproducing/managing the original clip #3 in the sub-path. In other words, the above-mentioned virtual playlist 63 includes a second reproduction scenario for performing data reproduction in the order of the original clip #3→the original clip #1 via the main path, such that the first reproduction scenario for performing data reproduction in the order of the original clip #1 →the original clip #2 by the first original playlist 61 is changed to the second reproduction scenario.

In association with the above-mentioned description, an additional index file or an additional object file, instead of the playlists, may also be adapted to change the reproduction scenario to another scenario. In this case, an index file contained in the virtual package is formed by combining the additional index file contained in the local storage with the original index file contained in the disc, and an object file contained in the virtual package is formed by combining the additional object file contained in the local storage with the original object file contained in the disc.

In the case of constructing an additional index file or additional object file contained in the local storage, if the original index file or the original object file contained in the disc are pre-included in the additional index file or the additional object file contained in the local storage, the binding operation replaces the additional index file or the additional object file contained in the local storage with the original index file or the original object file contained in the disc, such that the replaced files can be included in the virtual package.

In the case of extending the preferred embodiment shown in FIG. 9, the additional playlist file contained in the binding unit is directly replaced with the original playlist file contained in the disc by the binding operation, such that the replaced files can be contained as virtual playlist files in the virtual file structure. In this case, the replaced additional playlist file name and the replaced original playlist file name must be defined in the binding information.

For another example, the first preferred embodiment, the second preferred embodiment, and the third preferred embodiment can be integrated into one example, such that the integrated example can also be applied to the present invention. For example, specific auxiliary reproduction data (e.g., audio stream) may be added via the sub-path according to the first preferred embodiment, and at the same time a multiplexed AV stream may also be added to the result of the first preferred embodiment via the main path according to the second preferred embodiment.

A plurality of virtual playlists 63 are contained in the virtual package. For example, the virtual playlist bound by the first preferred embodiment of FIG. 7a, the virtual playlist bound by the second preferred embodiment of FIG. 8, and the virtual playlist bound by the third preferred embodiment of FIG. 9 may also be contained in a single virtual package. It will be obvious to those skilled in the art that this example is a modified example of the present invention.

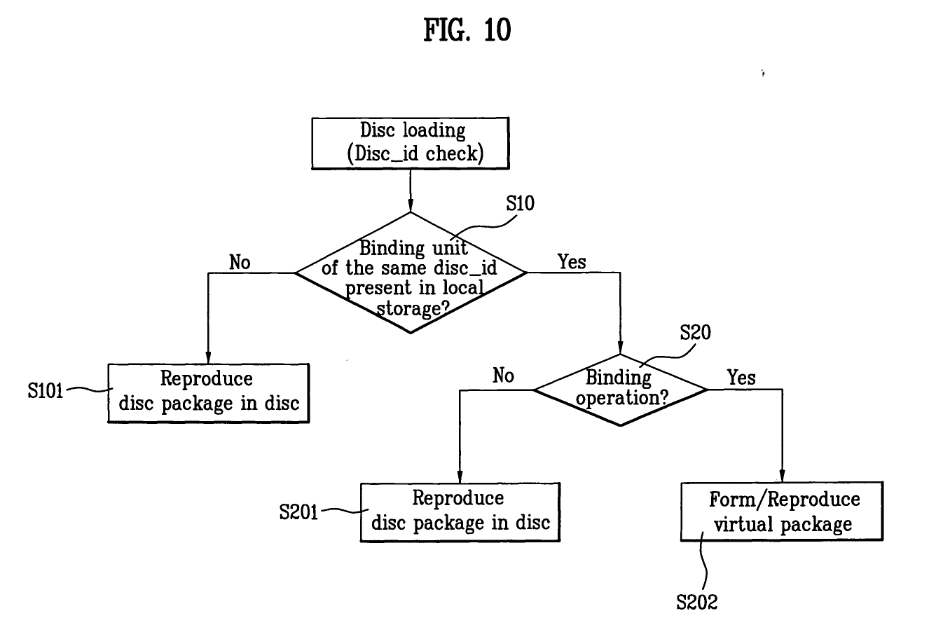

FIG. 10 is a flow chart illustrating a method for reproducing data from a recording medium using a local storage according to the present invention. Referring to FIG. 10, if a disc is loaded in an optical recording/reproducing device, the optical recording/reproducing device recognizes disc ID information (Disc_id), and determines whether additional data including a binding unit, which has the same disc ID information (Disc_id) as that of the loaded disc, is present in the local storage at step S10.

If it is determined that the binding unit is present in the local storage at step S10, the optical recording/reproducing device determines whether the binding operation for combining the binding unit with a file structure contained in a recording medium is performed at step S20. The optical recording/reproducing device forms the virtual package using the binding operation, and reproduces original data recorded in the disc and/or additional data recorded in the local storage using the formed virtual package at step S202.

If the binding unit is not present in the local storage at step S10, the optical recording/reproducing device reproduces original data using only the disc package recorded in the disc at step S101. If the binding operation is not required at step S20, the optical recording/reproducing device reproduces original data using only the disc package recorded in the disc at step S201.

Preferably, a predetermined step, which determines whether the loaded disc type is indicative of a disc for allowing disc data to be simultaneously reproduced along with additional data recorded in the local storage, may be further positioned prior to the above step S10. For example, provided that a disc (e.g., a BD-ROM) having version information of at least Version 1.1 is loaded in the optical recording/reproducing device, the reproduction method shown in FIG. 10 is performed. Otherwise, provided that a disc (e.g., a BD-ROM) having version information of Version 1.0 or less is loaded in the optical recording/reproducing device, the above-mentioned reproduction method shown in FIG. 10 is not performed, but the optical recording/reproducing device reproduces only the original data recorded in the disc.

As apparent from the above description, a method and apparatus for reproducing data from a recording medium using a local storage according to the present invention can effectively reproduce the original data recorded in the recording medium and the additional data stored in the local storage, resulting in the creation of more convenient functions for a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reproducing data of a recording medium using a local storage, comprising the steps of:
(a) reading a binding unit associated with a specific recording medium from the local storage;
(b) forming a virtual file structure using a binding operation for combining the binding unit with a file structure recorded in the recording medium; and
(c) reproducing data contained in the recording medium and/or data contained in the local storage using the formed virtual file structure.

2. The method according to claim 1, wherein the binding operation is executed by binding information.

3. The method according to claim 2, wherein the binding information defines a location at which a specific file contained in the binding unit is positioned in the virtual file structure.

4. The method according to claim 2, wherein the binding unit contained in the local storage is determined by the binding information.

5. The method according to claim 2, wherein the binding information is configured in the form of a single file for each recording medium.

6. The method according to claim 2, wherein the binding information is downloaded from an external part, and is then stored in the local storage.

7. The method according to claim 1, wherein the binding unit read from the local storage includes at least one file having the same identification (ID) information as that of a loaded recording medium.

8. The method according to claim 7, wherein the data recorded in the local storage using cannot be reproduced by only the file constructing the binding unit.

9. The method according to claim 1, wherein the binding unit includes a playlist file (PlayList).

10. The method according to claim 9, wherein the playlist file contained in the binding unit includes at least one sub-playitem (SubPlayItem), and the sub-playitem (SubPlayItem) includes information for reproducing data stored in the local storage.

11. The method according to claim 10, wherein the data recorded in the local storage, i.e., the local storage data, reproduced by the sub-playitem (SubPlayItem) is indicative of a sync type audio stream synchronized with the data recorded in the recording medium.

12. The method according to claim 10, wherein the data recorded in the local storage, i.e., the local storage data, reproduced by the sub-playitem (SubPlayItem) is indicative of a non-sync type audio stream unsynchronized with the data recorded in the recording medium.

13. The method according to claim 10, wherein the data recorded in the local storage, i.e., the local storage data, reproduced by the sub-playitem (SubPlayItem) is indicative of at least one of a text subtitle stream, an interactive graphic (IG) stream, and a presentation graphic (PG) stream.

14. The method according to claim 9, wherein the playlist file (PlayList) contained in the binding unit includes at least one playitem (PlayItem), and the playitem (PlayItem) includes file information for simultaneously reproducing the data recorded in the recording medium and the data recorded in the local storage.

15. The method according to claim 14, wherein the playitem reproduces/manages specific data, and the specific data is indicative of an Audio/Video (AV) stream wherein video data and audio data are multiplexed.

16. The method according to claim 9, wherein the playlist file (PlayList) contained in the binding unit includes at least one playitem (PlayItem) and at least one sub-playitem (SubPlayItem).

17. The method according to claim 1, wherein the virtual file structure formed by the binding operation includes a new playlist file formed by combining a playlist file contained in the binding unit with a playlist file contained in the recording medium.

18. The method according to claim 1, wherein the virtual file structure formed by the binding operation includes a new playlist file formed by replacing a playlist file contained in the binding unit with a playlist file contained in the recording medium.

19. The method according to claim 1, further comprising the step of:
employing a virtual file system to simultaneously reproduce the data recorded in the recording medium and the data recorded in the local storage using the formed virtual file structure.

20. The method according to claim 1, wherein the data stored in the local storage is downloaded from an external source.

21. A method for forming a virtual file structure, comprising the steps of:
(a) reading an original playlist file for reproducing original data recorded in a recording medium, and reading an additional playlist file associated with the original playlist file from a local storage;
(b) combining the original playlist file with the additional playlist file, and forming a virtual playlist file for reproducing the original data recorded in the recording medium and/or the additional data recorded in the local storage; and
(c) forming a virtual file structure which includes at least one virtual playlist file to reproduce the original data and/or the additional data.

22. The method according to claim 21, wherein the virtual file structure has the same structure as a file structure contained in the recording medium.

23. An apparatus for reproducing data of a recording medium, comprising:
a pickup unit for reading original data from a recording medium;
a local storage for storing additional data associated with the original data; and
a controller for forming a virtual file system to reproduce the original data and/or the additional data, and forming a virtual file structure including the original data and associated additional data using the virtual file system.
